(19) United States
(12) Patent Application Publication
(10) Pub. No.: US 2008/0020844 A1
(43) Pub. Date: Jan. 24, 2008

(54) System, Terminal and Method for Influencing a Course of Payment

(75) Inventor: Jens Petter Hoili, Oslo (NO)

Correspondence Address: BIRCH STEWART KOLASCH & BIRCH, PO BOX 747, FALLS CHURCH, VA, 22040-0747, US

(73) Assignee: Fair Chance Group AS, Oslo (NO)

(21) Appl. No.: 11/793,589

(22) PCT Filed: Dec. 19, 2005
(86) PCT No.: PCT/NO05/00467

§ 371 Date: Aug. 31, 2007

(30) Foreign Application Priority Data
Dec. 23, 2004 (NO) 20045616

(51) Int. Cl. A63F 9/24; G06F 17/00

(52) U.S. Cl. 463/42; 235/375; 463/17

(57) ABSTRACT

The invention relates to a system for influencing the course of payment during a transaction. The system comprises a point-of-sale terminal, arranged to provide an amount that has to be paid for the transaction; a lottery terminal, comprising a processing device, a first operating device for operation by a customer, and a first display device for reading by the customer; and a lottery server, operatively connected with the lottery terminal. The lottery terminal is arranged to receive an order for purchase of a lottery ticket, transmit a lottery participation inquiry to the lottery server, receive a lottery participation result from the lottery server, and if the lottery participation result indicates a prize, display a notification concerning the prize on the first display device. The lottery server is arranged to receive a lottery participation inquiry from the lottery terminal, provide a lottery participation result on the basis of the lottery participation inquiry, and transmit the lottery participation result to the lottery terminal. The point-of-sale terminal is arranged to cause the amount that has to be paid for the transaction to be reduced, cancelled or credited if the lottery participation result indicates a prize.

### TECHNICAL FIELD

The present invention relates to lottery and retail technology.

More specifically, the invention relates to a system, a terminal and a method for influencing the course of payment during a transaction.

### BACKGROUND OF THE INVENTION

Integrated point-of-sale terminals and lottery terminals are known in the prior art. For example, WO-03/094119 discloses a method for playing a game, which comprises performing a commercial transaction associated with a transaction price, receiving a ticket number and receiving a prize in the event of a predetermined relation between the ticket number and the transaction prize.

### SUMMARY OF THE INVENTION

An object of the present invention is to provide a system for influencing the course of payment during a transaction.

In particular, it is an object of the invention to provide a system, a terminal and a method for reducing or cancelling an amount that has to be paid during the course of payment as a result of a communication and processing sequence performed in interaction between a lottery server and a lottery terminal.

It is also an object to provide a system which offers both implementation of participation in a lottery and influence of the course of payment during a transaction, where the amount that has to be paid during the transaction is influenced by the outcome of the participation in the lottery.

It is a further object to provide solutions like those mentioned above, which eliminate or reduce the disadvantages associated with the prior art.

The invention will become apparent from the following independent claims.

Advantageous embodiments are indicated in the dependent claims.

### BRIEF DESCRIPTION OF THE DRAWINGS

The invention will now be described in greater detail with reference to an embodiment, illustrated by the attached drawings, in which

FIG. 1 is a block diagram illustrating the schematic structure of a system according to the invention, and

FIG. 2 is a flow chart schematically illustrating a method according to the invention.

### DETAILED DESCRIPTION OF THE INVENTION

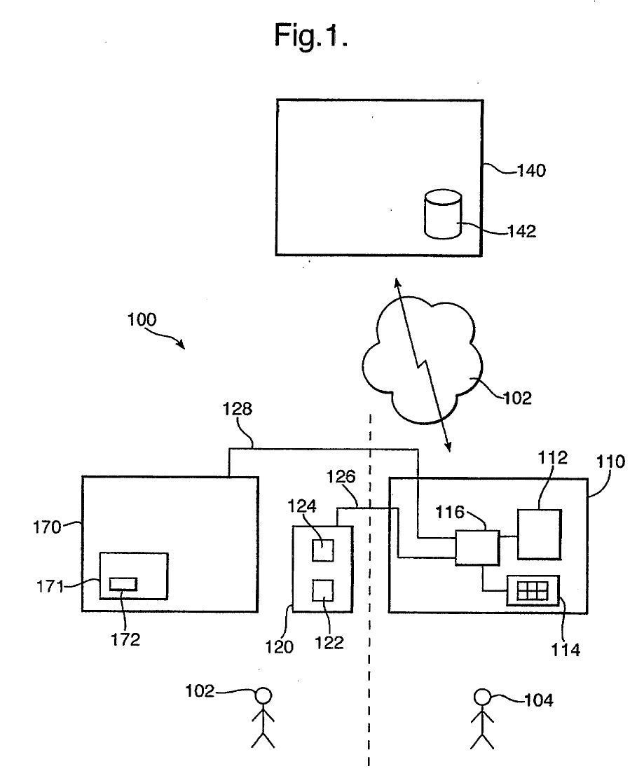

FIG. 1 is a block diagram illustrating the schematic structure of a system according to the invention.

The system is arranged to influence the course of payment during a transaction. The system comprises a point-of-sale terminal 170, a lottery terminal 110 and a lottery server 140.

A customer 104 is located at a sales point, and is served by a point-of-sale operator 102 such as a check-out attendant in a shop. The point-of-sale operator 102 operates a point-of-sale terminal 170 such as an ordinary cash register. The point-of-sale terminal 170 is therefore arranged to be operated by the point-of sale operator 102, normally by means of a keyboard (not shown) and a device for reading optical or electronic tags on goods, for example a bar code reader (not shown). The point-of-sale terminal 170 normally further comprises a hard-wired or wireless payment terminal, arranged to perform a payment transaction with an external payment system after completion of the transaction. For the basic object of the invention, however, it is sufficient for the point-of-sale terminal 170 to be arranged to provide an amount 172 that has to be paid for the transaction. This may, for example, involve data corresponding to the amount 172 being stored in a register such as an electronic memory in the point-of-sale terminal 170.

As a result of the invention the course of payment is influenced during the transaction. In particular, the amount 172 that the customer has to pay for the transaction is caused to be reduced or cancelled as a result of a communication and processing sequence performed in interaction between the lottery terminal 110 and the lottery server 140. For this purpose the point-of-sale terminal 170 is arranged to receive notification whether a lottery participation result indicates a prize, and if so to cause the amount 172 that has to be paid for the transaction to be reduced or cancelled.

This notification may be supplied to the point-of-sale terminal in different ways. In a preferred case the point-of-sale terminal 170 may be arranged to receive such notification from a communication link 128 between the point-of-sale terminal 170 and the lottery terminal 110. The communication link 128 may be hard-wired, for example a serial communication via a cable, or wireless, for example based on Bluetooth communication.

As an alternative, the notification may be given to the point-of-sale operator 102, who influences the amount 172 in a manual fashion by operating the keyboard on the point-of-sale terminal.

In a particularly advantageous embodiment the step of causing the amount 172 to be reduced or cancelled involves cancelling the amount, i.e. setting the amount the customer has to pay at zero. In more technical terms this can be done by zeroing the content of the register or the memory location where the amount is kept stored. In this way a particularly expedient advantage is achieved, where by participating in the lottery the customer can “win today's bargain” if he wins a prize. However, the step may instead involve reducing the amount, which may be similarly implemented by reducing the content of the register or the memory location where the amount is kept stored. This may be advantageous, for example if the solution at application level involves a “ceiling” for the prize that can be achieved. If, for example, the solution is to be implemented where the customer can win today's bargain, but with an upper limit of NOK 500, the said step will involve cancelling the amount if the amount was less than or equal to NOK 500, while it will involve reducing the amount to NOK 500 if the amount was greater than NOK 500.

Even though it is stated that the point-of-sale terminal is arranged to cause the amount that has to be paid for the transaction to be reduced or cancelled if a prize is won, it should be understood that a similar, advantageous effect will be achieved if the point-of-sale terminal is alternatively arranged to credit the customer, for example by issuing a credit note indicating a credit on the corresponding amount.

The lottery terminal 110 comprises a processing device 116 such as a microprocessor, a first operating device 114 such as a keyboard, for operation by the customer 104, and a first display device 112 such as a display to be read by the customer 104. The first operating device 114 and the first display device 112 may be integrated in an advantageous manner in one and the same physical unit, in the form of a touch-sensitive display.

By means of instructions which can be executed by the processor 116, being contained in a computer program stored in a memory (not shown) which is operatively connected with the processor 116, the lottery terminal 110 is arranged to perform the following steps:

(1) The lottery terminal 110 is arranged to receive an order for purchase of a lottery ticket. This order is normally received from the customer by reading the first operating device 114.

(2) The lottery terminal 110 is further arranged to transmit a lottery participation inquiry to the lottery server 140. This is normally done by the processor 116 transmitting such an inquiry via a wireless communication link 102, such as a WLAN, UMTS or GSM link, to the lottery server 140. It will be realized that the communication is not necessarily conducted directly between the lottery terminal 110 and the lottery server 140, but that it may alternatively be conducted via a number of different servers, networks and sub-networks, for example the processor 116 may activate a wireless local connection such as a Bluetooth communication to an intermediate computer or a network component arranged to pass on the notification to the lottery server 140 via a second hard-wired or wireless form of communication and/or protocol. The actual inquiry can be performed by a single, identifiable message.

(3) The lottery terminal 110 is further arranged to receive a lottery participation result from the lottery server 140. This result is generated and transmitted by the lottery server 140 as indicated under points (ii) and (iii) below.

In a special embodiment, where the system offers two lotteries simultaneously, the lottery terminal 110 is further arranged to receive an additional lottery participation result from the lottery server 140.

(4) The lottery terminal 110 is further arranged to establish whether the lottery participation result indicates a prize, and if so, to display a notification concerning the prize on the first display device 112. This is normally carried out by the processor 116 activating display of a message in the form of text and/or graphic symbols on the display device 112.

In the special embodiment where the system offers two lotteries simultaneously, the lottery terminal is further arranged to establish whether each of the received lottery results indicates a prize, and to display a notification concerning such prizes on the display device 112.

The lottery terminal 110 advantageously further comprises a second operating device 122 for operation by the point-of-sale operator. In this case the lottery terminal is further advantageously arranged to receive the order for purchase of a lottery ticket on operation of the second operating device. In the simplest version the second operating device 122 may consist of a push button.

In a special embodiment of the lottery terminal arranged to give the user access to additional services as a result of the first operating device 114 having been operated. In this case the user's purchase of a lottery ticket will act as an “admission ticket” to the additional services. In particular, such an additional service may result in the amount that has to be paid being reduced even when the lottery participation result does not indicate a prize. This may result, for example, in the amount that has to be paid being reduced by an amount corresponding to the stake for the ticket purchase. As a consequence of this the user receives the ticket free of charge if the user selects an additional service of this kind.

The lottery terminal 110 advantageously further comprises a second display device 124 for reading by the point-of-sale operator. In this case the lottery terminal is further advantageously arranged to display the notification concerning a prize on the second display device 124. In the simplest version the second display device 124 may consist of an indicator, for example an indicator lamp, which indicates notification concerning the prize. Alternatively, it may comprise a display for displaying text and/or graphics.

The second operating device 122 and the second display device 124 are advantageously included in one and the same remote control device or “pad” 120. The communication between the remote control device (the pad) 120 and the lottery terminal 110 may be conducted by means of a hard-wired 126 or wireless (not shown) communication link.

The lottery server 140 is operatively connected with the lottery terminal 110, preferably by a wireless communication link 102, as described above.

The lottery server 140 is arranged to perform the following steps:

(i) The lottery server 140 is arranged to receive a lottery participation inquiry from the lottery terminal, as described under point (2) above.

(ii) The lottery server 140 is further arranged to provide a lottery participation result on the basis of the lottery participation inquiry. This is implemented by the server “drawing lots” by generating a ticket number and then making an inquiry in a database 142 in the lottery server where a pre-drawn list of results associated with the ticket number concerned is pre-stored.

In particular, a random or pseudo-random ticket number is generated in the lottery server 140 by means of a random generator. Preferably, and for reasons of security, a hardware-based random generator is employed. A non-retroactive draw is preferably employed, i.e. ticket numbers that have already been drawn are not available in subsequent draws.

Thus in the simplest version the lottery server 140 is arranged to generate a binary result that indicates whether or not the lottery participation inquiry has resulted in a prize.

(iii) The lottery server 140 is further arranged to transmit the lottery participation result to the lottery terminal via the wireless communication link 102.

In the special embodiment where the system offers participation in two lotteries simultaneously, the lottery server may be arranged to provide an additional lottery result, and to transmit this additional lottery result to the lottery terminal via the wireless communication link.

As an alternative to the last-mentioned case an additional lottery server (not illustrated) may be installed which provides the additional lottery result, and which is also arranged to receive a lottery participation inquiry from the lottery terminal, to provide a lottery result, for example in the same way as that explained above, and moreover to transmit the lottery participation result to the lottery terminal via a wireless communication link. In this case, with separate servers for independent provision of lottery results, the servers preferably respond to one and the same lottery participation inquiry transmitted from the lottery terminal. Alternatively, the servers may respond to separate lottery participation inquiries transmitted from the lottery terminal.

The lottery server 140 is further arranged for communication with external computers via a network. This communication may, for example, be conducted via virtual private networks implemented via the Internet, or by other Internet-based network communication, preferably secure/encrypted communication such as by means of SSL.

For example, the lottery server may be arranged to communicate with a computer on the premises of a public lottery supervision authority, in such a manner that this authority has access to inspection and control of the database 142.

Furthermore, the lottery server may be arranged to communicate with an administration server, for example via a local network, where for its part the administration server is arranged to provide a web-based interface for administration and supervision related to users, sales premises, lottery terminals, ticket series, etc.

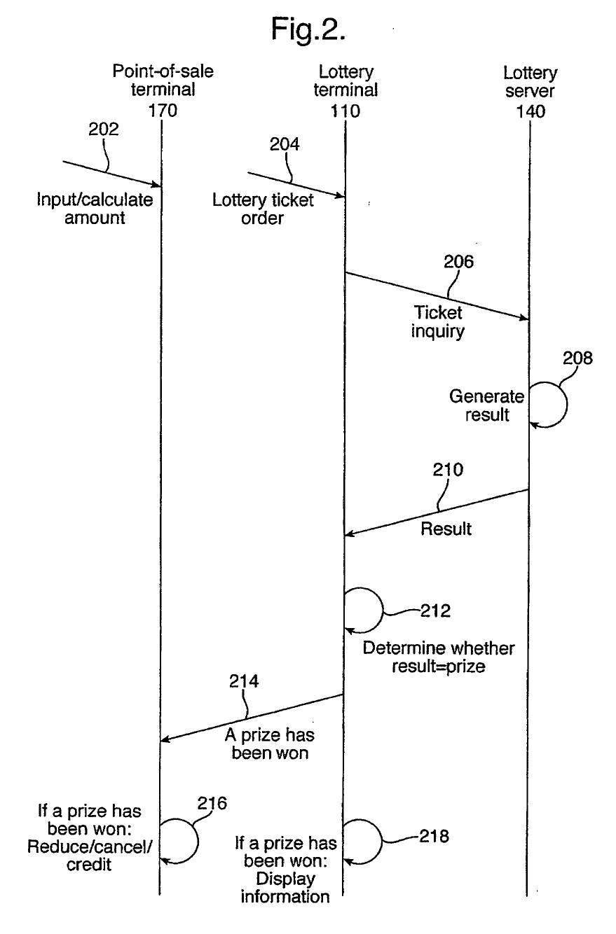

FIG. 2 is a flowchart schematically illustrating a method according to the invention.

The three vertical lines should be associated with the point-of-sale terminal 170, the lottery terminal 110 and the lottery server 140 respectively. Each arrow in the figure indicates either an action involving a communication between two of these three system units, where the arrow extends from one vertical line to another, or an action performed internally in the individual unit, where the arrow extends from a vertical line back to the same vertical line.

At 202 an initial step is illustrated involving the point-of-sale terminal 170 providing an amount that has to be paid for the transaction. In an individual case this may involve a point-of-sale operator inputting a partial amount for the goods by means of a keyboard or an optical bar code reader. These are added up in the point-of-sale terminal 170 to the amount which has to be paid for the transaction, and which is contained in a register or a memory location. The sales terminal 170 may comprise, constitute or be included in a cash register.

At 204 a second initial step is illustrated involving an order concerning a lottery ticket, i.e. an order from the customer concerning participation in a lottery. After receiving such an order the lottery terminal 110 is arranged to transmit 206 an inquiry concerning the lottery ticket to the lottery server 140. The lottery server 140 receives this inquiry, whereupon the step 208 of providing a lottery participation result is performed in the lottery server, as already discussed above with reference to FIG. 1. This lottery participation result is returned 210 to the lottery terminal 140.

In the lottery terminal 140 a step 212 is performed internally to determine whether the result indicates a prize. In the simplest version this step 212 is a triviality, since in this case, the result received by the lottery terminal in step 210 directly indicates whether or not a prize has been won.

If the received result indicates a prize, the lottery terminal is caused to transmit 214 a notification to the point-of-sale terminal 170 that a prize has been won. As indicated earlier, this notification may be provided either automatically or manually. In either case, in step 216 the point-of-sale terminal, in response to the notification, will cause the relevant amount associated with the transaction and preferably stored in a memory register in the point-of-sale terminal 170 to be reduced or cancelled, or alternatively credited. Furthermore, in step 218 a notification is displayed concerning a prize on the lottery terminal. The notification is displayed by the lottery terminal 110 on the first display device 112 for reading by the customer, possibly also on the second display device 124 for reading by the point-of-sale operator.

The above detailed description of the invention is provided as a non-limiting example of a preferred embodiment. Those skilled in the art of lottery and retail technology, however, will realize that numerous variations and alternatives exist within the scope of the invention.

In particular, it will be understood that the system, as illustrated in FIG. 1, is a simplified, schematic system depicting a minimum configuration. In practice, it is advantageous if a large number of lottery terminals are employed, which, for example may be physically located in shops scattered over the whole country, or alternatively or in addition across country boundaries. A lottery server may be arranged to serve a large number of lottery terminals, for example several thousand terminals. It will easily be appreciated that such a lottery server may be geographically located far from the lottery terminals, for example in a different part of the country or in a different country. Where the system's components are scattered over country boundaries, operatively/communicatively connected via a network, it should be pointed out that the crucial factor for evaluating the scope of protection for the present invention is that the system is put into effect at the location where a lottery terminal can be operated, which is independent of the physical location of the lottery server and any other terminals and/or servers included in the system.

As mentioned, the expression “that an amount will be reduced or cancelled” should preferably be understood to also cover the provision of a credit for the amount concerned or parts of the amount.

The detailed description indicates that the point-of-sale terminal may, for example, be a cash register, operated by a point-of-sale operator. It will be appreciated, however, that the principle of the invention applies equally well to the case where the point-of-sale terminal is an unattended terminal which provides and administers the amount that has to be paid for a transaction. One example of this is where the point-of-sale terminal comprises, constitutes or is included in a vending machine, which can be operated by means of coins, banknotes, payment/credit card or mobile communication-based payment means. Another example is where the point-of-sale terminal comprises, constitutes or is included in an unattended registration and payment terminal for use in self-service shopping.

Even though the present invention can obviously be used in connection with public/communal commercial premises such as shops (for example grocery stores, petrol stations or kiosks), it will be realized that the invention's sphere of application is not limited thereto. For example, the invention may be employed in shopping via the Internet. In this case the point-of-sale terminal and the lottery terminal may both be realized by the user's computer, since this executes a web browser, which communicates with the web server(s) providing the necessary point-of-sale terminal and lottery terminal functionality, in addition to the lottery server.

Further variants and modifications will be apparent to those skilled in the art. The scope of the invention will therefore be apparent from the following patent claims and their equivalents.

1. A system for influencing the course of payment during a transaction, comprising
a point-of-sale terminal, arranged to provide an amount that has to be paid for the transaction,
a lottery terminal, comprising a processing device, a first operating device for operation by a customer, and a first display device for reading by the customer, and
a lottery server, operatively connected with the lottery terminal,
where the lottery terminal is arranged to:
receive an order for purchase of a lottery ticket,
transmit a lottery participation inquiry to the lottery server,
receive a lottery participation result from the lottery server,
if the lottery participation result indicates a prize, display a notification concerning the prize on the first display device,
where the lottery server is arranged to:
receive a lottery participation inquiry from the lottery terminal,
provide a lottery participation result on the basis of the lottery participation inquiry, and
transmit the lottery participation result to the lottery terminal, and
where the point-of-sale terminal is arranged to:
if the lottery participation result indicates a prize, cause the amount that has to be paid for the transaction to be reduced or cancelled.

2. A system according to claim 1,
where the lottery terminal further comprises a second operating device for operation by the point-of-sale operator,
where the lottery terminal is further arranged to receive the order for purchase of a lottery ticket by operating the second operating device,
where the lottery terminal further comprises a second display device for reading by the point-of-sale operator, and
where the lottery terminal is further arranged to display the notification concerning a prize on the second display device.

3. A system corresponding to one of the claims 1-2,
where the lottery participation result is transmitted from the lottery terminal (110) to the sales terminal (170) via an electronic communication link.

4. A lottery terminal in a system for influencing the course of payment during a transaction, where the system comprises
a point-of-sale terminal for operation by a point-of-sale operator, arranged to
provide an amount that has to be paid for the transaction, and
if a lottery participation result indicates a prize, cause an amount that has to be paid for the transaction to be reduced or cancelled, and
a lottery server operatively connected with the lottery terminal, arranged to
receive a lottery participation inquiry from the lottery terminal,
provide a lottery participation result on the basis of the lottery participation inquiry, and
transmit the lottery participation result to the lottery terminal,
which lottery terminal comprises a processing device, a first operating device for operation by a customer and a first display device for reading by the customer, and is arranged to
receive an order for purchase of a lottery ticket,
transmit a lottery participation inquiry to the lottery server,
receive a lottery participation result from the lottery server,
if the lottery participation result indicates a prize, display a notification concerning the prize on the first display device.

5. A lottery terminal according to claim 4,
further comprising a second operating device for operation by the point-of-sale operator,
further arranged to receive the order for purchase of a lottery ticket by operating the second operating device,
further comprising a second display device for reading by the point-of-sale operator, and
further arranged to display the notification concerning a prize on the second display device.

6. A lottery terminal according to one of the claims 4-5,
further comprising the step of transmitting the lottery participation result from the lottery terminal (110) to the point-of-sale terminal (170) via an electronic communication link.

7. A method for influencing the course of payment during a transaction, comprising:
in a point-of-sale terminal for operation by a point-of-sale operator, providing an amount that has to be paid for the transaction,
in a lottery terminal, comprising a processing device, a first operating
device for operation by a customer, and a first display device for reading by the customer:
receiving an order for purchase of a lottery ticket,
transmitting a lottery participation inquiry to the lottery server,
receiving a lottery participation result from the lottery server,
if the lottery participation result indicates a prize, displaying a notification concerning the prize on the first display device,
in a lottery server, operatively connected with the lottery terminal:
receiving a lottery participation inquiry from the lottery terminal,
providing a lottery participation result on the basis of the lottery participation inquiry, and
transmitting the lottery participation result to the lottery terminal, and
in the point-of-sale terminal, if the lottery participation result indicates a prize, causing the amount that has to be paid for the transaction to be reduced or cancelled.

8. A method according to claim 7, further comprising
in the lottery terminal, receiving the order for purchase of a lottery ticket by operating a second operating device for operation by the point-of-sale operator, and
in the lottery terminal, displaying the notification concerning the prize on a second display device for reading by the point-of-sale operator.

9. A method according to one of the claims 7-8, further comprising transmitting the lottery participation result from the lottery terminal (1 10) to the point-of-sale terminal (170) via an electronic communication link.

10. A system for implementing participation in a lottery and influencing the course of payment during a transaction,
where the result of the participation in the lottery causes a modification in the amount that has to be paid for the transaction.
